(19) United States
(12) Patent Application Publication
(10) Pub. No.: US 2005/0282032 A1
(43) Pub. Date: Dec. 22, 2005

(54) SMOOTH OUTER COATING FOR COMBUSTOR COMPONENTS AND COATING METHOD THEREFOR

(75) Inventors: Bhupendra Kumar Gupta, Cincinnati, OH (US); Edward John Emilianowicz, West Chester, OH (US); Mohamed Muneeruddin, Lynnfield, MA (US)

Correspondence Address: HARTMAN AND HARTMAN, P.C., 552 EAST 700 NORTH, VAIPARAISO, IN, 46383, US

(73) Assignee: GENERAL ELECTRIC COMPANY, Schenectady, NY (US)

(21) Appl. No.: 10/904,053

(22) Filed: Oct. 21, 2004

Related U.S. Application Data
(63) Continuation-in-part of application No. 10/710,110, filed on Jun. 18, 2004.

(51) Int. Cl. B32B 15/00

(52) U.S. Cl. 428/621; 428/655

(57) ABSTRACT

A coating and method for reducing the incidence of cracking in a combustor assembly of a gas turbine engine, and particularly combustor assemblies of at least two components that are welded together to define a weld region that is prone to cracking at combustion temperatures sustained within the combustion chamber of the gas turbine engine. At least the surface of the weld region protected by a coating system comprising a thermal-sprayed metallic bond coat and a ceramic coating deposited on the bond coat. The ceramic coating is deposited by thermal spraying a powder having a particle size of not greater than 10 micrometers, and the outer surface of the coating system is smoother than the outer surface of the bond coat on which the ceramic coating is deposited.

### CROSS REFERENCE TO RELATED APPLICATIONS

This is a continuation-in-part patent application of co-pending U.S. patent application Ser. No. 10/710,110, filed Jun. 18, 2004.

### BACKGROUND OF THE INVENTION

The present invention generally relates to components employed in high temperature operating environments, such as the hostile thermal environment of a gas turbine engine. More particularly, this invention relates to reducing the incidence of cracks forming in a combustor component of a gas turbine engine by applying a coating that reduces the convective and radiant heat transfer to the component.

A conventional gas turbine engine of the type for aerospace applications has a combustor with an annular-shaped combustion chamber defined by inner and outer combustion liners. The upstream ends of the combustion liners are secured to an annular-shaped dome that defines the upstream end of the combustion chamber. A number of circumferentially-spaced contoured cups are formed in the dome wall, with each cup defining an opening in which one of a plurality of air/fuel mixers, or swirler assemblies, is individually mounted for introducing a fuel/air mixture into the combustion chamber.

To minimize weight and promote combustor efficiency, the dome and liners may be integrally welded together. Under some circumstances, component regions in and adjacent the welds may exhibit a propensity for cracking, which is believed attributable to the high radiative heat transfer to which the components are subject. On this basis, convective cooling by impingement and film cooling of the welded regions has been attempted to inhibit cracking. However, such attempts have not been successful.

### BRIEF SUMMARY OF THE INVENTION

The present invention generally provides a coating and method for reducing the incidence of cracking in a combustor assembly of a gas turbine engine. More particularly, the invention concerns combustor assemblies that comprise at least two components welded together to define a weld region, and where the weld region and regions adjacent thereto are prone to cracking at combustion temperatures sustained within the combustion chamber of the gas turbine engine.

According to a preferred aspect of the invention, at least the surface of the weld region exposed to combustion flames during operation of the gas turbine engine is protected by a coating system comprising a thermal-sprayed metallic bond coat and a ceramic coating deposited on the bond coat. The ceramic coating is deposited by thermal spraying a powder having a particle size of not greater than ten micrometers, and the outer surface of the ceramic coating is smoother than the outer surface of the bond coat on which the ceramic coating is deposited.

The method of this invention also involves reducing convective and radiant heat transfer to gas turbine engine combustor assemblies that comprise at least two components welded together to define a weld region that is prone to cracking. The method entails thermal spraying a metallic bond coat on a surface of the weld region, depositing a ceramic coating on a surface of the bond coat by thermal spraying a powder having a particle size of not greater than ten micrometers, and then processing the ceramic coating to form an outer surface that is smoother than the surface of the bond coat on which the ceramic coating is deposited.

The coating system of this invention is preferably characterized by a dense ceramic coating that has sufficiently low emissivity and low thermal conductivity to be capable of thermally protecting the weld region from thermal radiation incident on the combustor assembly. Low thermal radiation absorption by the ceramic coating, preferably in combination with backside cooling of the weld region, effectively minimizes the temperature within the weld region to the degree that the incidence of cracking is reduced and the overall reliability of the combustor assembly is significantly improved.

Other objects and advantages of this invention will be better appreciated from the following detailed description.

### BRIEF DESCRIPTION OF THE DRAWINGS

FIG. 1 is a partial cross-sectional view through a single annular combustor structure.

FIG. 2 is a cross-sectional view of a weld region that joins the dome and inner liner of the combustor structure of FIG. 1, and shows a coating system in accordance with a first embodiment of this invention.

FIG. 3 is a cross-sectional view of a coating system in accordance with a second embodiment of this invention.

### DETAILED DESCRIPTION OF THE INVENTION

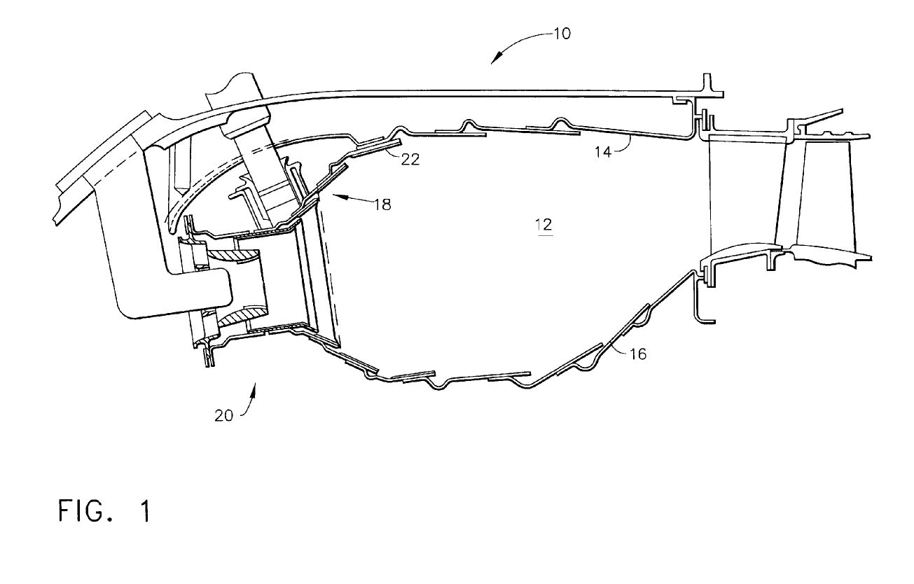

The present invention will be described in reference to a combustor 10 of an aerospace gas turbine engine depicted in FIG. 1. A portion of the combustor 10 is shown in cross-section in FIG. 1. The combustor 10 generally defines an annular-shaped combustion chamber 12 delimited by an outer liner 14, an inner liner 16, and a domed end or dome 18. FIG. 1 shows the domed 18 as including a swirl cup package 20. The combustor dome 18 is generally die-formed sheet metal attached by welding to the outer and inner liners 14 and 16. Suitable materials for the liners 14 and 16, dome 18, and the weld material include nickel, iron and cobalt-base superalloys, such as a cobalt-base alloy having a nominal composition of, by weight, about 40% cobalt, about 22% chromium, about 22% nickel, and about 14.5% tungsten. The liners 14 and 16 and dome 18 are subjected to the combustion flame and the resulting very high temperatures that exist within the combustor 10. As an apparent result of the high temperatures sustained by the liners 14 and 16 and dome 18, the weld region between these components, and particularly the weld region 22 between the inner liner 16 and the dome 18, are prone to cracking.

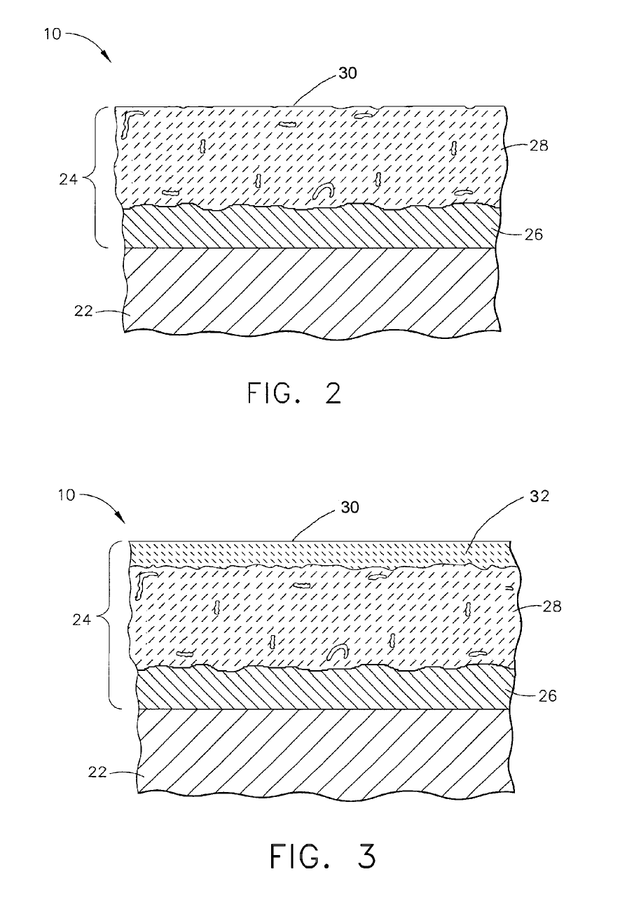

As a solution to this problem, the present invention provides a thermally-reflective coating system that covers at least the crack-prone weld region 22 of the combustor 10. A suitable coating system 24 is represented in FIG. 2 as comprising a metallic bond coat 26 over which a ceramic layer 28 is deposited. The bond coat 26 is depicted as having a rough surface as a result of being deposited by a thermal spraying process, such as low pressure plasma spraying (LPPS) or air plasma spraying (APS). A preferred chemistry for the bond coat 26 is a nickel-base MCrAlY alloy containing, by weight, about 10 to 20% chromium, about 15-25% aluminum, and about 0.3-1.0% yttrium, though it is foreseeable that other oxidation-resistance compositions could be used. The surface roughness of the bond coat 26 is at least 10 micrometers Ra, more preferably at least 12 micrometers Ra, which promotes the adhesion of the ceramic layer 28 to the bond coat 26. The bond coat 26 is deposited to a thickness of about 100 to about 400 micrometers, more preferably about 200 to about 300 micrometers, which is sufficient to provide a reservoir of aluminum that, when exposed to the oxidizing environment of the combustion chamber 12, forms an adherent alumina scale (not shown) that promotes the adhesion of the ceramic layer 28.

The present invention seeks to reduce the amount of heat transferred to the welded region 22 by the combustion flame and hot combustion gases by forming the ceramic layer 28 to have an appropriate macrostructure and surface finish. In particular, FIG. 2 represents the ceramic layer 28 as having a substantially dense macrostructure and a smooth outer surface 30. The density of the ceramic layer 28 is at least 5% of theoretical, and more preferably at least 10% of theoretical. The outer surface 30 has a surface roughness of at most 3 micrometers Ra, more preferably 2 micrometers Ra or less. Consequently, the outer surface 30 of the ceramic layer 28 has a smoother surface finish than the underlying surface of the bond coat 26.

Both the density and surface finish of the ceramic layer 28 is achieved at least in part by the process and materials used to deposit the ceramic layer 28. More particularly, the ceramic layer 28 is deposited by thermal spraying (e.g., APS) an ultra-fine ceramic powder with a maximum particle size of about 10 micrometers, more preferably in a range of about 1 to about 2 micrometers. The thermal spraying process results in the ceramic layer 28 being built up by fine “splats” of molten material, yielding a degree of inhomogeneity and the fine porosity depicted in FIG. 2. The ultra-fine powder used promotes the density of the ceramic layer 28, as well as the smoothness of its outer surface 30, by promoting the filling spaces between adjacent particles within the ceramic layer 28 to maximize density and at its surface 30 to reduce its surface roughness. If the desired surface roughness of the ceramic layer 28 is not attained with the thermal spraying process, the surface 30 of the ceramic layer 28 can be polished mechanically or by hand. The ceramic layer 28 is deposited to a thickness of about 200 to about 800 micrometers, more preferably about 400 to about 600 micrometers, which is sufficient to provide an effective thermal barrier between the weld region 22 and the hostile thermal environment within the combustion chamber 12. Suitable materials for the ceramic layer include zirconia stabilized by about 6 to about 8 weight percent yttria, though it is foreseeable that other ceramic materials could be used.

While thermal barrier coatings have been used in the past on combustion components, the coating system 24 of this invention differs in microstructure, surface finish, and purpose. For example, in commonly-assigned U.S. Pat. No. 6,047,539 to Farmer, a ceramic coating is deposited to have vertical microcracks, thereby resulting in a segmented macrostructure that renders the coating resistant to particle erosion and thermal strain.

FIG. 3 represents a second embodiment of the invention in which the desired surface for the coating system 24 is achieved by overcoating the ceramic layer 28 with a smooth outer coating 32. The outer coating 32 can be further tailored to serve as a barrier to thermal radiation, while also potentially having the advantage of being more resistant to erosion and infiltration than the ceramic layer 28. Preferred compositions for the outer coating 32 include aluminum oxide (alumina; Al₂O₃). Suitable processes for depositing the outer coating 32 include thermal spray techniques. A suitable thickness for the outer coating 32 is in the range of about 25 to about 200 micrometers, more preferably about 25 to about 50 micrometers. If necessary, the outer coating 32 can also be polished by hand or mechanical to achieve the desired outer surface finish for the coating system 24.

The coating systems 24 represented in FIGS. 2 and 3 reduce the temperature of the weld region 22 over which the coatings 24 are deposited by reducing the convective and radiant heat transfer to the weld region 22. In particular, the outer surface 30 defined by either the ceramic layer 28 or the outer coating 32 is sufficiently smooth to significantly reduce heat transfer by convection and radiation to the weld region 22. The limited porosity within the ceramic layer 28 also potentially serves as radiation-scattering centers to reduce heating of the weld region 22 by thermal radiation. Additional cooling of the weld region 22 can be achieved by directing cooling air, in the form of impingement and/or film flow, at the backside of the weld region 22 (i.e., opposite the coating system 24).

While the invention has been described in terms of a preferred embodiment, it is apparent that other forms could be adopted by one skilled in the art, such as by substituting other TBC, bond coat and substrate materials. Accordingly, the scope of the invention is to be limited only by the following claims.

1. A combustor assembly of a gas turbine engine, the combustor assembly comprising at least two components welded together to define a weld region that is prone to cracking at combustion temperatures sustained in the gas turbine engine, the weld region having a surface exposed to flames during operation of the gas turbine engine, the surface being protected by a coating system comprising a thermal-sprayed metallic bond coat and a ceramic coating deposited on the bond coat by thermal spraying a powder having a particle size of not greater than 10 micrometers, the coating system having an outer surface that is smoother than an outer surface of the bond coat on which the ceramic coating is deposited.

2. A combustor assembly according to claim 1, wherein the ceramic coating has a thickness of about 200 to about 800 micrometers.

3. A combustor assembly according to claim 1, wherein the outer surface of the coating system is a surface of the ceramic coating that has been polished to have a surface roughness of not greater than 3 micrometers Ra.

4. A combustor assembly according to claim 1, wherein the ceramic coating has a density of at least 5% of theoretical.

5. A combustor assembly according to claim 1, wherein the ceramic coating has a chemical composition consisting essentially of zirconia, yttria and incidental impurities.

6. A combustor assembly according to claim 1, wherein the ceramic coating has a chemical composition consisting essentially of about 6 to about 8 weight percent yttria, the balance being zirconia and incidental impurities.

7. A combustor assembly according to claim 1, wherein the bond coat has a chemical composition consisting essentially of nickel, chromium, aluminum, and yttria.

8. A combustor assembly according to claim 1, wherein the bond coat has an average surface roughness Ra of at least 10 micrometers.

9. A combustor assembly according to claim 1, further comprising means for convective cooling a surface of the weld region opposite the surface protected by the coating system.

10. A combustor assembly according to claim 1, wherein the combustor assembly comprises a liner and a dome, and the weld region metallurgically joins the combustor liner and the dome.

11. A method of reducing convective and radiant heat transfer to a combustor assembly of a gas turbine engine, the combustor assembly comprising at least two components welded together to define a weld region that is prone to cracking at combustion temperatures sustained in the gas turbine engine, the weld region having a surface exposed to flames during operation of the gas turbine engine, the method comprising the steps of:
thermal spraying a metallic bond coat on the surface of the weld region;
depositing a ceramic coating on a surface of the bond coat by thermal spraying a powder having a particle size of not greater than 10 micrometers; and then
processing the ceramic coating to form an outer surface that is smoother than the surface of the bond coat on which the ceramic coating is deposited.

12. A method according to claim 11, wherein the ceramic coating is deposited to a thickness of about 400 to about 600 micrometers.

13. A method according to claim 11, wherein the processing step comprises polishing the ceramic coating to have a surface roughness of not greater than 2 micrometers Ra.

14. A method according to claim 11, wherein the ceramic coating is deposited to have a density of at least 10% of theoretical.

15. A method according to claim 11, wherein the ceramic coating has a chemical composition consisting essentially of zirconia, yttria and incidental impurities.

16. A method according to claim 11, wherein the ceramic coating has a chemical composition consisting essentially of about 6 to about 8 weight percent yttria, the balance being zirconia and incidental impurities.

17. A method according to claim 11, wherein the bond coat has a chemical composition consisting essentially of nickel, chromium, aluminum, and yttrium.

18. A method according to claim 11, wherein the bond coat is deposited to have an average surface roughness Ra of at least 12 micrometers.

19. A method according to claim 11, further comprising the step of convective cooling a surface of the weld region opposite the surface protected by the coating system.

20. A method according to claim 11, wherein the combustor assembly comprises a liner and a dome, and the weld region metallurgically joins the combustor liner and the dome.
